(19) United States
(12) Patent Application Publication
(10) Pub. No.: US 2003/0134409 A1
(43) Pub. Date: Jul. 17, 2003

(54) Delivery vehicles for environmental remediants

(76) Inventors: Thomas E. Mallouk, State College, PA (US); Bettina Schrick, Deisenhofen (DE); Jennifer L. Blough, State College, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/210,371

(22) Filed: Aug. 1, 2002

Related U.S. Application Data
(60) Provisional application No. 60/310,292, filed on Aug. 3, 2001.
(60) Provisional application No. 60/368,398, filed on Mar. 22, 2002.

(51) Int. Cl. B09B 3/00; C12S 1/00

(52) U.S. Cl. 435/262.5

(57) ABSTRACT

The invention provides novel environmental remediants and methods for remediating contaminated soils, earth, ground, or groundwater, particularly subsurface sites. The environmental remediants comprise a chemically or biologically active material, in the form of a particles which are on average less than about one micron, and a carrier which is interactive with an environmentally acceptable solvent. The carrier is capable of maintaining the particles in a persistent suspension which can permeate soil pores due to it small size, thereby delivering the remediant to the subsurface contamination. Significant advantages over prior art methods, particularly for metallic nanoparticles, are avoiding agglomeration, ease of application, and delivery to subsurface sites. Methods are provided which comprise selecting an appropriate environmental remediant and contacting a subsurface soil or water with the remediant; by applying the remediant in a composition with a carrier, wherein the remediant transits to the subsurface site.

### CROSS REFERENCE TO RELATED APPLICATIONS

This application claims benefit of U.S. Provisional Application No. 60/310,292, filed Aug. 3, 2001, and U.S. Provisional Application No. 60/368,398., filed Mar. 22, 2002. The entirety of each of these applications is incorporated by reference herein.

### INVENTION RIGHTS UNDER FEDERALLY SPONSORED RESEARCH

Pursuant to 35 U.S.C. §202(c), it is acknowledged that the U.S. government has certain rights in the invention described herein, which was made in part with funds from National Science Foundation Grant Numbers CHE-0095394 and CHE9529202 and the US Department of Energy Contract # DE-FG07-97ER14822.

### FIELD OF THE INVENTION

This invention relates to the field of environmental remediation. In particular, this invention relates to novel environmental remediants and methods for their delivery in situ to contaminated surface or subsurface soil or water.

### BACKGROUND OF THE INVENTION

Remediation of contaminated soils or water continues to pose technological challenges. Reliable remediation technologies are needed for the decontamination of major environmental contaminants, including radionucleides, halogenated organic compounds, heavy metals and other toxic compounds.

A major source of problems, for example, is soil contamination by chlorinated hydrocarbons, which are primarily introduced into the environment near the soil surface. These contaminants travel from the surface and typically pass through the region below the soil surface composed of soil, sand, clay, silt, minerals, organic matter, and water, before eventually reaching the groundwater level. Consequently, nearly all sites containing organic contaminants have the highest concentrations of contaminants in the vadose zone near the source. It follows that remediation strategies must be tailored for both the vadose and groundwater zones.

Prior vadose zone remediation methods include soil vapor extraction, pump-and-treat methods, heat treatment, bioremediation, electroosmosis, injection of reactive material (e.g. oxidizers such as Fenton reagents, and reducing agents such as zero-valent metals), and the in situ placement of reactive metal barriers. These technologies have drawbacks such as expense, labor, effectiveness and practicality. Their performance depends on several factors, but among the most critical is the difficulty in accessing the subsurface.

Zero-valent metal nanoparticles are powerful remediants for chlorinated hydrocarbons, polychlorinated biphenyls (PCB's), other halogenated organics, and reducible metal ions, such as Cr(VI), As(V), Hg(II), and Pb(II), however, these remediant particles are not well-behaved in the soil environment. The colloidal chemistry of the particles is subject to disruption. Metal nanoparticles tend to agglomerate and to adhere to silicate particles, which are negatively charged near neutral pH.

For application to groundwater remediation, metal nanoparticles have been pumped through an injection well, where they flowed with the waste plume into the aquifer. As with vadose zone remediation, controlling the flow and adsorptive properties of such nanoparticles in groundwater have posed problems in their effective utilization.

A need therefore exists for effective, cost-efficient environmental remediation of subsurface soil or water contamination. In particular, methods and compositions for delivery of effective environmental remediants, such as nanoparticles, to contaminated subsurface soil or water would confer a great benefit upon mankind.

### SUMMARY OF THE INVENTION

Provided in the present invention are novel environmental remediants and methods for their delivery. The environmental remediants comprise chemically or biologically active material in the form of particles with average diameter of less than about one micron together with a carrier for enhanced permeability of overlaying soils. The remediants are delivered to a contaminated subsurface soil or water. In preferred embodiments, the particles are colloidal nanoparticles and the carrier is a carbonaceous or polymeric molecule which does not bind substantially to the soil, sand, silt, clay, soil organic matter, or minerals in the vadose zone. Alternatively, the carrier may be designed to bind preferentially to one soil component, such as the soil organic matter, where the remediant nanoparticles are most needed.

In one aspect, the invention is directed to environmental remediants comprising at least one chemically or biologically active particulate material. The particles have a mean diameter of less than one micron, as measured by optical or electron microscopy. These preferred remediants further comprise a polymeric carrier, such carrier being soluble or miscible or capable of forming a suspension in an environmentally acceptable solvent. The polymeric carrier is capable of suspending the particles in the solvent, or maintaining them in suspension for a greater time than such particles would be suspended in the absence of the carrier.

The invention also provides environmental remediants comprising a particle for augmenting the elimination of an environmental contaminant from a remediation site and polymeric support molecules, wherein the particle has an effective diameter of one micron or less, as determined by optical or electron microscopy. In a preferred embodiment, the particle has reactive or catalytic properties for detoxifying the environmental contaminant.

In another aspect, the invention is directed to environmental remediants for remediating contaminated soil or water comprising at least one chemically or biologically active material comprising particles having average diameter, as measured by optical or electron microscopy, less than about one micron; and further comprising a carrier which is soluble or miscible or which forms a suspension in an environmentally acceptable solvent where at least a majority of the particles are capable of transiting at least 30 cm of soil following application of the remediant to the surface of the soil or injection of the remediant into the subsurface, or upon irrigating the soil with additional solvent.

The invention is also directed to methods of reducing the presence of a contaminant in subsurface soil or water comprising the steps of: selecting an environmental remediant which is chemically or biologically active with the contaminant; and contacting the subsurface soil or water with a composition comprising the remediant in the form of particles of mean diameter less than about one micron, as measured by optical or electron microscopy, together with a carrier which is soluble or miscible or which forms a suspension in an environmentally acceptable solvent, where the amount of remediant is effective to detoxify the contaminant.

Additional features and advantages of the present invention will be understood by reference to the drawings, detailed description and examples that follow.

### BRIEF DESCRIPTION OF THE DRAWINGS

FIG. 1 is a graphical representation of data for the dehalogenation of trichloroethylene (TCE) in water by supported (Open Square symbols) and unsupported bimetallic nanoparticles (Solid Square symbols). Iron filings were used as low surface area controls (Open circle symbols). 0.50 g Ni—Fe/C (66 mg metals) in 40 ml water was spiked with 1.8×10⁻⁴ M TCE. TCE was removed to the detection limit (6 ppb) within 150 minutes by both supported and unsupported nanoparticles. Also depicts differences in remediation rate between Fe—Ni nanoparticles supported on carbon (BET surface area ˜66 ml/g) and low surface area, uncatalyzed iron filings (BET surface area ˜2.6 m²/g).

Various terms relating to aspects of the present invention are used hereinabove and also throughout the specification and claims. The terms “support,” “detoxify,” “diameter,” “environmentally acceptable,” and “persistent suspension” are defined below.

The term “support” as used herein is synonymous with the term “carrier.” The terms “detoxify” or “detoxification” refer to the conversion of an environmental contaminant to a substance less toxic than the environmental contaminant. The process of detoxification includes any process which results in the conversion of the environmental contaminant to, for example, nontoxic compounds, to compounds less toxic than the environmental contaminant, or to complexes of the environmental contaminant with itself or other compounds. Some examples of detoxification include, but are not limited to oxidation, reduction, hydrogenation, dehalogenation (e.g. dechlorination), precipitation, and complexing.

The term “diameter” as used herein refers to its usual meaning wherever that meaning can be applied. Otherwise, diameter is a measure of the effective size of particulate matter, independent of its shape, and is an inquiry into the ability of a molecule to permeate the interstitial space of soil pores. For example a molecule may be roughly spherical and ‘diameter’ refers to its actual diameter. Where a molecule, for example a polymeric carrier, is substantially nonspherical, e.g. substantially linear, the average diameter may refer to the coil diameter of the polymer, or another measure of the effective diameter which would operationally limit the ability of the molecule to transit through or permeate soil pores. Thus the term is functional and practical rather than strictly academic. For particles, effective diameter can be determined by optical or electron microscopy as is appropriate for the particular material in question.

The term “environmentally acceptable” as applied to a solvent, refers to a solvent fluid, which is substantially acceptable for use in the environment of interest, and in which a carrier of the invention may be solubilized, mixed or suspended. The fluid may be a liquid or other fluid recognized as having solvent properties, for example a supercritical fluid. Examples of environmentally acceptable solvents include, but are not limited to water and water solutions, alcohols (e.g. ethyl or isopropyl), acetone, and supercritical carbon dioxide. Environmentally acceptable solvents are generally recognized as substantially benign with respect to the environment of interest, and at least have no permanent deleterious effect on the environment of interest, for example the environment to be remediated. The environmental acceptability of a solvent may be considered relative to the environmental contaminant to be detoxified.

The term “persistent suspension” where used herein refers to suspension of matter in a solvent wherein about 50% or more of the suspended matter remains in suspension for at least about 24 hours or more.

The present invention is directed to environmental remediants and methods for their delivery to contaminated soil or water. In particular, there are described novel uses of polymeric carriers for suspending or carrying environmental remediants for delivery to subsurface sites of contaminated soil or water, substantially overcoming limitations of the prior art and making valuable contributions to efforts to clean environmental contaminants.

The present invention is directed to environmental remediants comprising at least one chemically or biologically active material, in the form of particles having average diameter, as measured by optical or electron microscopy, less than about one micron; and a polymeric carrier which is substantially soluble or miscible, or which forms a suspension in an environmentally acceptable solvent, wherein the polymeric carrier is capable of maintaining the particles in suspension in the solvent for a period of time longer than they would remain suspended without the polymeric carrier.

In preferred embodiments, the chemically or biologically active material comprises a reactive or catalytic material. The selection of the specific remediant will be highly situation-specific. For example, the specific remediant chosen will often depend on the characteristics and spatial distribution of the contaminant within the site to be remediated. Examples of chemically active compounds useful for remediation are known to those of skill in the art. Such chemicals are able to detoxify, as defined herein, environmental contaminants. In some cases, the chemical compound may be catalytic and accelerate a reaction that would otherwise occur but more slowly. Examples of chemically active remediants include but are not limited to metals (e.g. zero-valent metals), metal oxides, and nonmetal oxides.

Biological molecules are particularly useful to remediate certain contaminants. For example, certain enzymes such as monooxygenases and dioxygenases specifically catalyze the detoxification of a toxic substrate into a less toxic, or nontoxic product. In some embodiments, an enzyme fragment, for example a fragment containing an active site, is useful to detoxify the substrate as well. Biological organisms are known to have utility for decontamination of certain contaminant compounds and such biological organisms are also compatible with embodiments of the present invention. Oxidation of numerous environmental contaminants by aerobic bacteria is known in the art, as is reductive dechlorination by anaerobic bacteria and co-metabolic and non cometabolic detoxification of a variety of compounds including trichloroethylene (TCE).

Further examples of environmental compounds known to be degradable by biologically active remediants include but are not limited to aromatic and aliphatic hydrocarbons; PCB's, petroleum compounds, for example, a variety of fuel and oil compounds and the additive MTBE; polynuclear aromatic hydrocarbons, for example coal tar, creosote, naphthalene and a wide variety of carcinogenic compounds; and volatile organic carbons, for example, chloroform, benzene, toluene and xylene. Other biological molecules can bind with great affinity or avidity to specific contaminants. For example, various metal binding proteins are know to those of skill in the art and these proteins, such as metallothionein can bind to heavy metal contaminants.

The invention provides remediants having the ability to reduce or eliminate the harmful environmental effects of the contaminant of interest. The harmful effects can be reduced or eliminated by, for example, binding to the contaminant, converting the contaminant to something less toxic, or otherwise detoxifying the contaminant as defined above. Some examples of U.S. patents that discuss the type of remediants and contaminants applicable to the present invention include: U.S. Pat. Nos. 5,615,975; 5,634,983; 6,100,382; 5,975,798; 6,242,663; 5,545,331, all hereby incorporated by reference.

A presently preferred embodiment features particles comprising metallic nanoparticles. In such embodiments of the invention, the nanoparticles contain one or more metals selected from Ag, Al, Au, Cu, Fe, Mg, Ni, Pd, Pt and Zn. More preferably the nanoparticles contain iron. Zero valent iron is particularly effective as a remediant particle. Nanoparticles may comprise metals as well as other material. Mixtures of nanoparticles are within the scope of the present invention as well. More preferred are bimetallic nanoparticles or mixtures of metallic nanoparticles containing at least two metals, where a first metal has a reductant property and a second metal has a catalytic property. The first metal and the second metal are preferably in electrical contact with each other. Where nanoparticles containing iron as a first metal are used, preferred second metals include Pd, Pt and Ni. In presently preferred embodiments bimetallic nanoparticles with ratios of from about 1:1 to about 1:500 catalytic metal to reductant metal are effective as remediants.

The various aspects of the invention are not intended to be limited by the foregoing description of chemically or biologically active remediant compounds—they merely serve to exemplify chemically or biologically active compounds useful with the present invention.

A feature of the present invention is the particles comprising the chemically or biologically active material. The particles, in one aspect, are preferably small. While the particles are typically less than one micron with respect to average diameter, the majority of particles preferably are less than 500 nanometers with respect to average diameter. Even more preferable are particles which are less than 300 nm in effective diameter. Particles with a range of diameters are useful. Particles with a range of diameters of less than about 1 nm to less than about 1000 nm are preferred. In more preferred embodiments, particles range in diameter from less than about 30 nm to about 300 nm, from less than about 50 nm to about 200 nm, less than about 3 nm to about 30 nm, or from less than about 1 nm to about 100 nm. Particle size may be determined by a variety methods known in the art. Preferred methods of determining average particle diameter are microscopic methods, including optical and electron microscopy.

In another aspect, the surface-to-volume ratio of the particles and the polymeric carrier is preferably high relative to larger particles. High surface-to-volume ratios are particularly useful where the detoxification process requires, involves or is facilitated by surface interactions, such as adsorption, with the particles or the carrier.

In one aspect of the invention, the lifetime of the remediant particles in the environment is sufficiently long to allow detoxification of at least a portion of the contaminant. Therefore, it may be desirable to suppress certain parasitic processes, such as background corrosion of the remediant in the environment. In preferred embodiments the lifetime of the remediant in the environment is sufficiently long to allow substantial detoxification of the contaminant, or even complete detoxification of the contaminant. Most preferably, the lifetime of the remediant particles is considered in determining the total ‘dose’ of remediant required to deliver an amount effective to completely remediate the contaminant in one or more applications of the remediant, in a manner analogous to determining a course of therapy for a patient where a drug delivery system is used.

The polymeric carriers of the present invention are soluble, or miscible, or capable of forming a suspension, preferably a colloidal suspension, with an environmentally acceptable solvent as defined herein. The ability of the polymeric carriers to interact with the solvent by either dissolving, mixing or forming a suspension is a novel aspect of the present invention. The polymeric carrier interacts with the remediant particles on a chemical or physical basis, such that the polymeric carrier is capable of maintaining the particles in suspension in the solvent for longer than the particles would have remained in suspension in the solvent in the absence of the polymeric carrier. In preferred embodiments, the particles remain in suspension 10, 50, or 100 times longer in the presence of the carrier than in its absence. Preferred carriers are capable of maintaining the remediant in a persistent suspension, as defined herein. In more preferred embodiments the suspension formed is colloidal and is stable indefinitely. The advantage provided by this novel aspect of the present invention is particularly relevant where the remediant comprises zero valent metal nanoparticles. The particles are known to agglomerate and aggregate, which severely limits their utility for in situ remediation.

Laboratory assessment of polymeric carriers is facilitated, for example, on 30 cm soil columns by measuring the quantity or activity of a remediant eluting through a soil of interest. Preferred carriers are those which allow remediants to elute more extensively than remediants lacking the carrier. Other factors, such as speed of elution, may be considered in selecting a carrier. Additionally, carriers which transit some soils but bind to specific types of soil have utility for remediating contaminants bound to that soil.

The polymeric carriers are preferably porous material, and also have a large surface-to-volume ratio. In a presently preferred embodiment, the polymeric carrier is a carbonaceous material. The carrier comprises carbon made hydrophilic by chemical treatment, such as by treating Vulcan XC-72 carbon (Cabot Corp.) with a diazonium salt of benzenesulfonic acid according to the method of Belmont et al (U.S. Pat. No. 5,851,280). The carbon is believed to consist of platelets with edges made anionic by the treatment process.

In other preferred embodiments water-soluble polymers are selected for use as carriers. In particular, the polymeric carriers are preferably selected from synthetic polymers, microbial products, marine gums, seed gums, plant exudates and other natural hydrocolloids.

Presently preferred synthetic polymers for use as carriers herein include, but are not limited to, polyacrylic acid; copolymers of polyacrylic acid, polyacrylamides, copolymers of polyacrylamide, neutral polyacrylamides, anionic polyacrylamides, modified celluloses, modified starches, polyvinylalcohols; polyvinylpyrrolidone; polyvinylmethyl ether, polyvinylmethyl ether-maleic anhydride copolymers, poly(maleic anhydride-vinyl) copolymers, polyethylene oxide, polythyleneimines, carboxyvinyl polymers, carboxypolymethylene and polyethyleneglycol.

Examples of modified celluloses contemplated for use as carriers herein include, but are not limited to, alkyl celluose ethers, carboxymethylcellulose, carboxymethylhydroxyethylcellulose, ethylcellulose, ethylhydroxyethylcellose, hydroxylalkylcelluose ethers, hydroxyethylcellulose, hydroxymethylcellulose; hydroxypropylcellulose, hydroxypropylmethylcelluose, and methylcellulose.

Examples of modified starches contemplated for use as carriers herein include, but are not limited to, amylose, amylopectin, anionic oxidized starches, carboxymethylstarch, hydroxyethylstarch, and hydroxypropylstarch.

Examples of microbial products contemplated for use as carriers herein include, but are not limited to, bioalgin, curdlan, dextran, gellan, pullulan, rhamsan, scleroglucan, welan, and xanthan gums.

Examples of marine gums contemplated for use as carriers herein include, but are not limited to, agars, agarose, algins, alginates, alginic acid polymers, carrageenan and furocellan.

Seed gums contemplated for use as carriers herein include, but are not limited to, flaxseed gum, guar gum, locust bean gum, psyllium seed gum, quince seed gum, tamarind gum and tara gum. Presently preferred plant exudates for use as carriers herein include, but are not limited to, gum arabic, gum ghatti, gum karaya, gum larch, and gum tragacanth.

Examples of other natural hydrocolloids contemplated for use as carriers herein include, but are not limited to, arabinoxylin, caseins, galactomannans, gelatin, hemicelluose, lignite, lignosulfonates, pectins; starches, and tannins.

In a presently preferred embodiment, the polymeric carrier is negatively charged at the pH of use. In particular, the surface charge of the polymeric molecule should be considered. The pH of use is preferably between about pH 5 and about pH 9. More preferably, the pH of use is between about pH 6 and about pH 8. The carrier need not have a net negative charge over this entire range, but rather it is preferred that the carrier have a net negative charge at the pH which corresponds to the soil pH at the remediation site. The pH at this locus of remediation may be a narrower range, for example 6.8-7.5. A polymeric carrier which has a net negative charge at this pH is preferred.

Still more preferable are polymeric carriers which do not, under conditions of actual use, bind substantially to the soil, soil organic matter, sand, clay, or silt particles present at the locus of remediation, independent of the pH or net charge of the molecule. A preferred carrier will allow the remediant to permeate the soil substantially better than the same remediant in the absence of the carrier. One useful measure of this is the ability to elute the remediant from test soil column containing soil from the remediation site. Preferred carriers will facilitate 10-, 100-, or 1000-fold or more elution as compared with the same remediant in the absence of the carrier.

A highly preferred carrier has the ability to deliver the remediant particles to a contaminated subsurface soil or water without substantial losses due to binding to overlaying matter and without being excluded due to size restrictions of the soil pores. The more highly preferred carrier, therefore, is that carrier which stably suspends the remediant particles, which does not substantially bind to the overlaying or intervening soil layers and which permeates the soil pores at the remediation site from the surface through the vadose zone to deliver the remediant to the contaminated soil or water.

In another aspect, the environmental remediants can adsorb environmental contaminants. In a preferred embodiment, soil contaminants which are bound to soil and other particles at the remediation site preferentially adsorb to the environmental remediant and this adsorption process facilitates the detoxification of the contaminant. In preferred embodiments, the surfaces of the carrier or remediant particles provide adsorption sites for the contaminant. In more preferred embodiments, the adsorption sites are abundant and the contaminant tends to partition with the environmental remediant. In a highly preferred embodiment the adsorption sites are abundant and the adsorption process brings the contaminant in close proximity to the reactive or catalytic component of the remediant particles, thereby facilitating the detoxification process.

In another of its aspects, the invention provides environmental remediants comprising a particle for augmenting the elimination of an environmental contaminant from a remediation site, and a polymeric support molecule, wherein the particle has an effective diameter of 1 micron or less. This aspect of the invention is particularly useful wherein the remediants are catalysts or otherwise possess a chemically or biologically active material which augments the detoxification of an environmental contamination. It is known that certain contaminants are eliminated from the environment at extremely slow rates. The remediants may be catalysts which increase the rate of such reactions, or cofactors for a reaction, such as an enzymatic reaction, or growth factors for a biological organism which is present. In other embodiments the remediants will have reactivity with the contaminant or be capable of detoxifying the contaminant independent of the slow reaction already in place.

The environmental remediants offer the advantage of augmenting slow elimination rates by a variety of mechanisms, with the added advantage of being capable of delivery to a subsurface contamination site, whether soil or water. Where the remediants possesses adsorptive properties towards the contaminant, as discussed above, further advantages of the present invention become evident.

In preferred embodiments, the associations between a polymeric support molecule and a remediant particle can range from one of weak physical forces or chemical interactions to covalent bonds between the particle and the polymeric support material. Although the invention is in no way limited to a particular mechanism or type of association between the polymeric support molecules and the particles, in one embodiment, the polymeric support molecule comprises a macroscopic hydrophobic surface or ligating groups for retaining the particle. The ligating groups can comprise groups capable of binding in some fashion with the particles. Where the particles are nanoparticulate metals, useful ligating groups for the polymeric support material include but are not limited to aldehydes, alcohols, amines, carboxamates, carboxylates, ethers, hydroxamates, ketones, nitrites, phosphonates, phosphates, pyridines and sulfonates and other groups known to bind or interact with metals.

Also useful with the present invention are polymeric support molecules with effective average diameters smaller than the mean pore size of the various soil layers at the remediation site, in particular soil pores between the location of the application of the remediant and the desired destination for the remediant. For example, if a subsurface soil or water is to be treated, the polymeric support should be small enough to permeate the mean soil pores in the overlaying layers, as well as the vadose zone or intervening layers. As discussed above for carriers, the polymeric support molecule preferably does not substantially bind to soil, clay, silt, sand, silicates and other materials within the remediation site.

The polymeric support molecules are preferably soluble in a solvent, preferably an environmentally acceptable solvent and more preferably an aqueous solvent. Solubility in aqueous solvents facilitates the application and delivery of the environmental remediant, particularly to subsurface contamination. Also preferred are polymeric support molecules which are miscible and those which form suspensions, particularly suspensions stable for 24 hours or more, in the solvent.

In another aspect of the invention, environmental remediants for remediating contaminated soil or water are provided. The remediants comprise a chemically or biologically active material comprising particles having average diameter of less than one micron, and a carrier which is soluble in an environmentally acceptable solvent, wherein at least a majority of the particles transit at least 30 cm of soil following application to the surface of the soil or upon solvent irrigation of the soil.

In many typical remediation sites, the greatest difficulties are related to the subsurface contamination. Surface contaminants are easier to remediate through removal, or provide easy access for treatment. In one aspect, the present invention, provides an environmental remediant which transits the soil and permeates to a subsurface locus of remediation within the remediation site. This utility of the present invention offers a great advantage over existing environmental remediants in treating subsurface contamination.

In presently preferred embodiments, the environmental remediants are the preferred means of remediation for subsurface contaminants. The remediants can substantially or completely transit the vadose zone and reach contaminated subsurface soil or water.

The invention in another aspect provides methods for reducing the presence of a contaminant in subsurface soil or water. The methods comprise the steps of selecting an environmental remediant which is chemically or biologically active with the contaminant in the subsurface soil or water and contacting the subsurface soil or water with a composition comprising the remediant in the form of particles having mean diameter less than about one micron, as measured by optical or electron microscopy, together with a carrier which is soluble, miscible or can form a suspension in an environmentally acceptable solvent, in an amount effective to detoxify the contaminant, thereby reducing the presence of the contaminant in the subsurface soil or water.

In preferred embodiments, the contacting is performed by applying the remediant to the surface and allowing it to diffuse to the subsurface location, or it is washed, with further application of solvent or water, through the vadose zone to the subsurface soil or water. The contacting may also be carried out by any methods known to those of skill in the art for application of remediants to contaminated subsurface sites. For example, remediants can be injected through means known in the art, such as through the application of hydraulic or pneumatic pressure. Where excavation is conducted, subsurface contamination can be directly exposed at the surface and contacting can be through the direct application. Removed soil or water can also be treated and returned to the site or retained elsewhere.

The present invention is further described in the following examples. These examples are not to be construed as limiting the scope of the appended claims.

### EXAMPLE 1

Materials and Methods

Hydrophilic carbon-supported zero-valent nickel-iron (Ni—Fe/C) nanoparticles were developed as a reactive material for the dehalogenation of chlorinated hydrocarbons in groundwater and soils. Although Pd or Pt tend to be preferred materials because of greater catalytic activity and lower toxicity, Ni was selected for working examples. The permeability of Ni—Fe/C nanoparticles was tested by elution through columns packed with various model soils, and was compared to that of unsupported Ni—Fe and nanoparticles supported on silica, poly(acrylic acid), and poly(4-styrenesulfonate).

Bimetallic nickel-iron nanoparticles were prepared as described previously for nanoscale zero-valent iron (Ponder et al. Environ. Sci. Technol. 34:2564, 2000). Briefly, 6.5 g of FeSO₄.7H₂O (Aldrich), 1.6 g NiCl₂.6H₂O (Aldrich) and 6.1 g of hydrophilic carbon (Vulcan XC-72, Cabot Corp.), treated with the diazonium salt of benzenesulfonic acid as described below were dissolved in 100 ml of deionized water with stirring. After adjusting the pH to 6.2-7.0 with 3.8 M NaOH, the metal salts were reduced using 4.0 g NaBH₄ (Aldrich). The mixture was stirred for 20 min. and the particles were then collected by filtration under Ar using a 0.2 μm pore size nylon filter. Alternatively, the solid was separated from the liquid reaction mixture using a laboratory centrifuge. For the synthesis of palladium-coated nanoiron (Pd—Fe), a slight modification of the procedure described by Zhang et al. was used (Wang, C. B.; and Zhang, W. X.; Environ. Sci. Technol. 31: 2154, 1997.) Nanoiron was prepared using 6.2 g FeSO₄.7H₂O (Aldrich) in 100 ml deionized water (with pH adjusted to 6.0-7.0 as described above), which was reduced with 3.1 g solid NaBH₄ (Aldrich). The iron nanoparticles were then filtered, washed with water, and then immediately suspended in a solution of 0.1 g palladium (II) acetate [Pd(C₂H₃O₂)]₃ (47.5% Pd, Alfa Aesar) in 20 ml of ethanol.

The solid product was washed with water, and then with ethanol and acetone to eliminate water, and finally was dried under vacuum overnight. The same synthetic procedure was used with all other hydrophilic supports. These included PAA (polyacrylic acid, Aldrich), MW: ca. 2,000, and PSS (poly-sodium-4-styrenesulfonate 20% wt. in water, Aldrich), average MW: 1,000,000. A silica support consisting of 0.60 micron diameter spheres prepared by the Stober method (Stober et al. J. Colloid Interface Sci. 26:62, 1968) was also used.

The carbon support was made hydrophilic by treating an aqueous suspension of 16.8 g Vulcan XC-72 carbon (Cabot Corp.) with a solution of 1.2 g NaNO₂ and 2.6 g sulfanilic acid in water to which 1.5 ml concentrated hydrochloric acid was added. The reaction of sulfanilic acid with NaNO₂ and hydrochloric acid is known to produce the diazonium salt of benzenesulfonic acid, which is reactive with carbon particles, as described by Belmont et al. (U.S. Pat. No. 5,851,280). The mixture was stirred overnight and the solvent was then evaporated in a crystallizing dish held at 120° C. for 24 hrs. The resulting black flakes were then Soxhlet-extracted with ethanol for 24 hours.

TCE dehalogenation was tested using a purge and trap apparatus (Tekmar LCS-2) coupled to a gas chromatograph (Buck Scientific) equipped with a Restek MXT-502.2 60 m column and a DELCD detector. Headspace analysis was performed using a Hewlett-Packard 5890 GC/MS with a 30-m GasPro column (J&W).

To test the supported Ni—Fe/C nanoparticles for reactivity before and after permeation through a column of sand or soil, the suspension was eluted with water through a 1 cm×30 cm packed column. The eluted suspension was loaded into a 40 ml IChem vial (VWR) with a Teflon mininert valve or a PFFG-Teflon septum, and then spiked with 10 ml of 1.42 M TCE in methanol. The vial was monitored for TCE removal via purge and trap sampling, and for hydrocarbon product formation via headspace sampling. The reaction vials were rotated on a roller drum along their vertical axis at 11 rpm. The amount of Ni—Fe/C per vial was determined gravimetrically by evaporating the water in vacuum.

Headspace sampling was used to determine the amount of hydrogen produced by background corrosion during the TCE dehalogenation experiment using a Varian aerograph GC equipped with a TCD detector and an open tubular molecular sieve column.

Nitrogen BET surface analysis was performed using a Micromeritics ASAP 2010 surface area analyzer. Analysis for Fe and Ni was done by inductively coupled plasma atomic emission spectroscopy (ICP-AES).

Elution of Supported and Unsupported Nanoparticles Through Model Soils

To test the mobility of the support materials and particles in model soils, 1.5×14 cm, 30 ml polypropylene columns (Bio-Rad Laboratories) were used. The packing material was either standard Ottawa sand (200-700 μm particle size, E&M Science, CAS 14808-60-7), or three soils: Hagerstown, Pope and Chagrin soil. These three soils were characterized at the Pennsylvania State University Soil Characterization Laboratory (Table 1). They were stored at 4° C. and passed through a 2 mm mesh sieve prior to use.

The three model soils and Ottawa sand were tested using the following four suspensions: a.) 24.5 mg unsupported Ni—Fe (Ni—Fe) in 25 ml water, b.) 14.0 mg palladium-coated nanoiron (Pd—Fe) in 25 ml, c.) 50.0 mg (total weight) Ni—Fe on hydrophilic carbon support (Ni—Fe/C) in 20 ml, and d.) 50.0 mg (total weight) Ni—Fe on polyacrylic acid (Ni—Fe/PAA) in 20 ml water. Water used in these experiments was passed through a Nanopure II (Barnstead Int'l.) water system with a resultant resistivity of 18.3 MΩ-cm and a pH of 6.73.

The column ends were equipped with a two-way valve for control of flow rates. A small glass wool plug was pushed to the bottom of each column, to avoid drainage of the sand or soil through the column ends. Prior to the addition of nanoparticle suspension, the four columns were slurry-packed up to the 10 ml mark.

The sand or soil-packed columns were first rinsed with 12.00 ml water. The fractions exiting the columns were collected to determine the background elution of nickel and iron by ICP-AES from the soil/sand wash. The NiFe/C and Ni—Fe/PAA suspensions were passed through a 1 cm bed of Ottawa sand in a separate column to eliminate unsupported Ni—Fe particles.

To determine the flow rate of nanoparticle suspensions in the packed columns, 4.00 ml of the appropriate suspension (corresponding to 5-10 mg of suspended solids) was added to the top of a soil-packed column, and the valves at the bottom were quickly opened. Once the 4.00 ml suspension had flowed into the top of the soil or sand bed, 12.00 ml water was added to elute the suspensions through the columns. The gravity flow rate through the column was measured in ml/min (Table 1). The eluent was clear after rinsing with 12.00 ml of water for all the suspensions used.

The 16.0 ml fraction collected from each column was digested with HCl for Ni and Fe analysis. For each suspension, a 4.00 ml fraction that had not been added to the columns was set aside and analyzed by ICP-AES. The percent of metals that exited the column (with the background wash subtracted) relative to the initial metal concentration is listed in Table 1.

The retention of the support materials themselves was also evaluated using sand and soil-packed columns. Suspensions of PAA and hydrophilic carbon, at a concentration of 2.5 mg/ml were prepared. 4.00 ml of each suspension (corresponding to 10 mg of support) was introduced into freshly packed columns. The amount that passed through the columns was determined by measuring the weight after evaporation, relative to an evaporated 4.00 ml sample that was not passed through the column.

Results and Discussion

The Ni—Fe/C particles are easily isolated by microfiltration and form a persistent suspension when suspended in water. It is hypothesized, without limiting the invention to any particular means of operation, that their anionic surface charge and small particle size facilitate transport through soil- and sand-packed columns. Poly(acrylic acid) supported particles also had good permeability and formed a persistent suspension in water, but could be isolated in solid form by centrifugation. In contrast, unsupported Ni—Fe nanoparticles rapidly agglomerate in water and do not permeate any of the model soils tested. Ni—Fe/C particles retain their reactivity after elution and reduce trichloroethylene (TCE) rapidly to hydrocarbons. The initial rate of TCE reduction using Ni—Fe/C is comparable to that obtained with unsupported Ni—Fe, and is 280 times faster than the rate using iron filings. Ni—Fe/C is a soil-permeable remediant that may minimize the need for excavation, reduce the cost and environmental impact of remediation, and more efficiently target remediants that are delivered by injection into groundwater.

Transmission electron micrographs of the hydrophilic carbon support show that it contains approximately hexagonal flakes of 50-200 nm diameter along with some amorphous material. These carbon particles, either with or without metal, form a persistent suspension in water. The permeability of Ni—Fe nanoparticles on hydrophilic carbon and other supports was compared to that of unsupported nanoparticles in packed columns containing sand, sand mixed with zeolite A, topsoil, potting soil, and three characterized loams (Chagrin, Pope, and Hagerstown soils) from representative areas of the USDA soil textural triangle. The properties of these soils and the results of the elution studies are given in Table 1.

TABLE 1
Composition of model soils, and quantification of the percentage of nickel
and iron eluted from the soil and sand-packed columns.

| | Hagerstown | Pope | Chagrin | Ottawa |
|---|---|---|---|---|
| Soil type | (high silt) | (high sand) | (high clay) | sand |
| Sand % | 29.9 | 55.9 | 27.7 | 100 |
| Silt % | 46.2 | 25.4 | 38.0 | — |
| Clay % | 24.0 | 18.7 | 34.2 | — |
| Texture | Loam | Sandy Loam | Clay Loam | — |
| PH | 6.2 | 5.1 | 7.6 | — |
| Organic matter % | 2.7 | 3.3 | 2.8 | — |
| Water flow rate (mL/min) | 0.6 | 9.6 | 19 | 29 ± 1.7 |
| Ni-Fe/C 2.5 mg/mL | | | | |
| Flow rate (mL/min) | 0.2 ± 0.004 | 8.4 ± 0.6 | 13 ± 0.8 | 16 ± 1.9 |
| % Metals eluted | 0.0 | 2.0 | 28 | 39 |
| Ni-Fe/PAA 2.5 mg/mL | | | | |
| Flow rate (mL/min) | 0.4 | 9.3 | 19 | 30 ± 1.8 |
| % Metals eluted | 6.0 | 9.7 | 47.2 | 54.4 |
| Ni-Fe 0.98 mg/mL | | | | |
| Flow rate (mL/min) | not measured | 6.3 | 11.4 | 12 ± 0.4 |
| % Metals eluted | 0.0 | 0.0 | 3.0 | 0.8 |
| Fe-Pd 0.56 mg/mL | | | | |
| % Fe eluted | not measured | not measured | not measured | 1.8 |

Hydrophilic carbon supported Ni—Fe (13.3% Fe, 4.6% Ni) particles, PAA-supported Ni—Fe particles, and unsupported particles (1:4 Ni:Fe) were mixed with water and immediately loaded onto packed liquid chromatography columns. Equal amounts of suspensions containing unsupported and supported Ni—Fe were added to columns packed with 30 cm of standard Ottawa sand (E&M Science) of 200-700 mm particle size. The columns were eluted with water at equal rates.

The unsupported Ni—Fe nanoparticles penetrate less than 1 cm into the column, where they agglomerate and subsequently impede the flow of water through the column. The eluent from this column shows no color, indicating that neither iron nor iron oxide penetrates the column. This experiment must be done quickly after making the Fe—Ni suspension, because the nanoparticles tend to agglomerate rapidly when added to water.

In contrast, the hydrophilic carbon- and PAA-supported Ni—Fe nanoparticles form a persistent suspension in water. These supported particles flow through sand columns at nearly the same rate as water through the column. A small fraction of black particles, possibly those not attached to the carbon support, remain at the top of the column, and the remainder elute from the bottom of the column. Adding a 2 cm band of powdered zeolite 5A, a cation exchanger, did not have any effect on the flow behavior of the Ni—Fe/C colloids in sand columns. Different levels of elution were found with Hagerstown, Pope, and Chagrin soils. In each case the supported nanoparticles were able to permeate the soil more effectively than the unsupported particles, as shown in Table 1. Hagerstown soil, which had the slowest flow rate for Ni—Fe/C, also had the lowest percentage of metals eluted for all the suspensions and was the most strongly adherent to the support materials. In Pope soil, the mobility of the suspensions was slightly higher, but only a very small fraction of metals elute from the Pope-packed columns. The Chagrin soil and the sand, which had the fastest flow rates, also weakly retained the support materials and eluted the highest percentage of metals. The stickiest soils, Pope and Hagerstown, are relatively acidic. This suggests possible adhesion to cationic mineral surfaces, or to the organic components of these soils. An experiment done with a more concentrated Ni—Fe/PAA suspension (10 mg/mL) is consistent with this idea. In this case, the elution of metals was 74% and 94% from sand and Chagrin soil, respectively, but only 0.2% and 1.0% from Hagerstown and Pope, respectively. This suggests that strong adsorption sites are less abundant and easily saturated in the Chagrin soil, but less easily saturated in the more acidic Hagerstown and Pope soils. To increase elution of the remediants through these soils, these sites may be saturated in a variety of ways, for example increasing the concentration of the remediant applied, or increasing the concentration of the support itself without adding additional remediant nanoparticles.

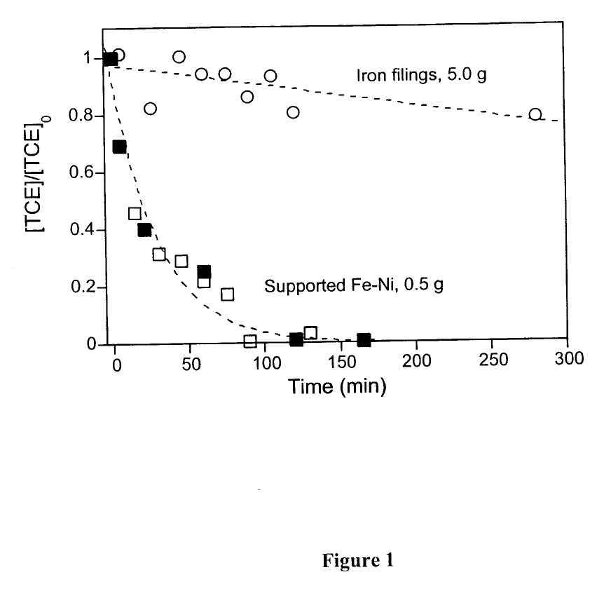

The reactivity of the Ni—Fe/C particles was unaffected by elution through these model soils. Headspace analysis of the Ni—Fe/C suspension exposed to TCE, before and after elution, showed identical distributions of hydrocarbon (ethane, propane, butane, pentane, etc.) dehalogenation products. These results are consistent with the reductive hydrodechlorination mechanism previously proposed for unsupported Ni—Fe nanoparticles. FIG. 1 shows the results of these batch tests, in which 0.50 g Ni—Fe/C (66 mg metals) in 40 ml water was spiked with 1.8×10⁻⁴ M TCE. TCE was removed to the detection limit (6 ppb) within 150 minutes by Ni—Fe/C. This is similar to the rate of removal found with 0.1 g of unsupported Ni—Fe. FIG. 1 also illustrates the striking difference in remediation rate between Fe—Ni nanoparticles supported on carbon (BET surface area ˜66 m²/g) and low surface area, uncatalyzed iron filings (BET surface area ˜2.6 m²/g).

Interestingly, the background corrosion rate of Ni—Fe/C may be substantially slower than that of unsupported Ni—Fe. In 40 ml neutral water the initial rates of hydrogen evolution were 0.246 and 1.59 mmol/hr with equal amounts of metal (66 mg). This preliminary result, which should be followed up with longer-term field tests, suggests a longer lifetime of the Ni—Fe/C colloids, but without a decrease in dechlorination rate.

Ni—Fe nanoparticles were also prepared on other hydrophilic anionic supports: 0.60 lm silica, PAA (polyacrylic acid), and PSS (poly-sodium-4-styrenesulfonate). Ni—Fe supported on PAA had good flow characteristics through sand and other model soils. Ni—Fe particles on PSS and silica were isolated by filtration and were added as aqueous suspensions to sand columns. Both materials adhered to the top of the column and could not be eluted with water.

The elution of PAA- and carbon-supported nanoscale metals through a range of model soils augurs well for their utilization in real environmental applications. The availability of a soil-permeable support could make the injection and dispersion of colloidal remediants more efficient. Supported nanometals can thus potentially reduce the cost and environmental impact of remediation, by minimizing the need for excavation and by more efficiently targeting remediants delivered by injection. The low mobility of PAA and hydrophilic carbon in porous soils (Pope and Hagerstown) needs to be studied in more detail, in order to understand the specific adsorption mechanism(s) and the effect of solution parameters such as pH and ionic strength. This should permit the design more effective delivery vehicles for a wider range of soils.

### EXAMPLE 2

A second set of experiments was performed similar to the above. Several bimetallic nanoparticle remediants were synthesized for use in remediation of TCE. The specific remediants used are listed in Table 1 and were prepared using methods similar to the above. Relative rates of corrosion of the remediants were determined by using gas chromatography to monitor the evolution of hydrogen gas in the water reduction equation 2H₂O+2e⁻→H₂+2OH⁻. The results were compared with the activity of the nanoparticles in TCE reduction to determine optimum remediation materials that dehalogenate TCE rapidly but corrode slowly. The results are provided in Table 1.

Solutions were prepared containing salts of the two metal in the respective ratio. For the remediants on supports, hydrophilic carbon or SiO₂ support materials were also used at a 20% loading. The metals were reduced with 4.0 g NaBH₄ and the resulting black particles were filtered and washed with H₂O, ethanol, and ether. Finally, the particles were dried in a vacuum overnight. Note that for the remediant labeled “mix” in Table 1, the metals were separately precipitated and then physically mixed after drying.

A purge and trap apparatus coupled with a GC was used to analyze TCE. For H₂ evolution studies, 1 ml of headspace gas, over a mix of water/TCE/nanoparticles, was injected directly into the GC.

Generally, the data show that Fe/Ni with the carbon carrier (Fe/Ni/C) has a lower initial hydrogen evolution rate than either unsupported Fe/Ni systems and SiO₂ supported remediants. Additionally, the Fe/Ni with carbon carrier gave rapid remediation of TCE and eluted through a sand packed column whereas unsupported or SiO₂ supported remediants did not. FIG. 2 shows a graph giving the relative rates of initial H₂ evolution and TCE removal for the various systems tested in Example 2 and listed in Table 1. Note that the column labeled “Lifetime particles (days)” is not strictly the lifetime of the systems tested but rather represents an extrapolation of the initial corrosion rate. In practice the corrosion slows down after several hours because of the formation of a passive oxide coating on the metal nanoparticles. These data are to be considered not as absolutes, but rather as indicative of the relative initial corrosion rates for nanoparticulate remediants in the presence or absence of supports (carriers).

The results suggest that preferred remediants for remediation of TCE include carbon supported nanoparticulate M/Fe (M=Ni, Pd, Pt). The physically admixed Ni/Fe nanoparticles also performed well with respect to these experiments but in the absence of carriers would not be expected to permeate the vadose layer to reach subsurface contaminants. Both systems had good relative and absolute rates of TCE remediation. In the experiment, both were used in a ratio of about 1:4 Ni/Fe. This seems to be a preferred ratio for Ni, although the remediant can be optimized to other ratios depending on the catalytic metal used (Ni, Pd, or Pt), the specific remediation project, the activity of the metal used, and relative cost of the metals.

Some conclusions from the second example include the following. Altering Fe/Ni ratio either increases or decreases activity with optimum ratios being between about 4:1 to 1:1. Fe is a preferred metal because of its activity and substituting Pd for Ni increases reactivity. Carbon supported Fe/Ni provides optimum corrosion/dehalogenation rates while also transporting the remediant to or through the vadose zone. A physical mixture of nanoparticles of Fe/Ni also corrodes slowly while dehalogenating relatively fast.

### EXAMPLE 3

### Prophetic Application

Halogenated hydrocarbons are commonly subsurface contaminants. In particular, chlorinated hydrocarbons are known to be subsurface contaminants of soil and water in many remediation sites. In applying the environmental remediants and methods of the present invention to decontaminating chlorinated hydrocarbons, the environmental remediant selected comprises bimetallic nanoparticles. The particles range in size from 30-300 nm and comprise preferably Pd—Fe, Pt—Fe or Ni—Fe in rations ranging from 1:1 to 1:500. The polymeric support material is hydrophilic carbon as discussed in the previous examples.

The remediant is applied to the surface of the remediation site, on a surface which overlays the subsurface soil or water to be treated. The remediant can be sprayed on, poured on or applied in any manner of applying a liquid to a solid surface. The remediation treatment may be in a single batch, or applied periodically depending on the requirements. Following application to the overlaying surface, the remediant may be further delivered into the subsurface layers through diffusion, or through a further application of solvent to help the remediant permeate the soil pores. The remediant is thereby placed in contact with the contaminant. Alternatively, a suspensions of the remediant may be injected into the subsurface by means of pneumatic or hydraulic pressure. In this case the increased mobility of the remediant in the subsurface provides an advantage over the use of suspensions of unsupported metal nanoparticles.

The contaminant is adsorbed onto adsorption sites of the remediant, and thereby becomes more susceptible to reaction with the metals. The chlorinated hydrocarbon is reductively dehalogenated by the remediant on exposure thereto. The detoxification is thorough and results in no accumulation of toxic by-products. The reduction of the contaminant is extensive, if not complete. If incomplete, further treatment can complete the process. Upon completely reducing the presence of the contaminant, no further clean-up or manipulation is required at the remediation site. Final samples are screened for the contaminant, and upon confirmation of the laboratory results the site can be pronounced clear of contamination.

The present invention is not limited to the embodiments described herein and exemplified above, but is capable of variation and modification without departure from the scope of the appended claims.

What is claimed is:

1. An environmental remediant comprising:
at least one chemically or biologically active material in the form of particles having average diameter, as measured by optical or electron microscopy, less than about one micron; and
a polymeric carrier, soluble, miscible or suspendable in an environmentally acceptable solvent, said polymeric carrier maintaining said particles in suspension in the solvent.

2. The environmental remediant of claim 1 having a net negative surface charge at a pH of use.

3. The environmental remediant of claim 2 wherein the pH of use comprises a pH of a subsurface locus of remediation.

4. The environmental remediant of claim 3 wherein the pH of the subsurface locus of remediation is between about 5 and about 9.

5. The environmental remediant of claim 1 wherein the polymeric carrier is associated with the remediant through a chemical or physical interaction.

6. The environmental remediant of claim 1 wherein the polymeric carrier comprises a porous material.

7. The environmental remediant of claim 1 wherein the polymeric carrier has a surface to volume ratio equal to or greater than the remediant.

8. The environmental remediant of claim 1 wherein the polymeric carrier comprises a water-soluble polymer.

9. The environmental remediant of claim 1 wherein the water-soluble polymer is synthetic polymer, microbial product, marine gum, seed gum, plant exudate, natural hydrocolloid or a mixture thereof.

10. The environmental remediant of claim 9 wherein the synthetic polymer is polyacrylic acid; copolymers of polyacrylic acid, polyacrylamides, copolymers of polyacrylamide, neutral polyacrylamides, anionic polyacrylamides, modified celluloses, modified starches, polyvinylalcohols; polyvinylpyrrolidone; polyvinylmethyl ether, polyvinylmethyl ether-maleic anhydride copolymers, poly(maleic anhydride-vinyl) copolymers, polyethylene oxide, polythyleneimines, carboxyvinyl polymers, carboxypolymethylene, polyethyleneglycol or a mixture thereof.

11. The environmental remediant of claim 10 wherein the modified cellulose is alkyl celluose ether, carboxymethylcellulose; carboxymethylhydroxyethylcellulose, ethylcellulose, ethylhydroxyethylcellose, hydroxylalkylcelluose ether, hydroxyethylcellulose, hydroxymethylcellulose; hydroxypropylcellulose, hydroxypropylmethylcelluose, methylcellulose or a mixture thereof.

12. The environmental remediant of claim 10 wherein the modified starch is anionic oxidized starche, carboxymethylstarch, hydroxyethylstarch, hydroxypropylstarch or a mixture thereof.

13. The environmental remediant of claim 9 wherein the microbial product is bioalgin, curdlan, dextran, gellan, pullulan, rhamsan, scleroglucan, welan, xanthan gum or a mixture thereof.

14. The environmental remediant of claim 9 wherein the marine gum is agar, agarose, algin, alginate, alginic acid polymer, carrageenan, furocellan or a mixture thereof.

15. The environmental remediant of claim 9 wherein the seed gum is flaxseed gum, guar gum, locust bean gum, psyllium seed gum, quince seed gum, tamarind gum, tara gum or a mixture thereof.

16. The environmental remediant of claim 9 wherein the plant exudate is gum arabic, gum ghatti, gum karaya, gum larch, gum tragacanth or a mixture thereof.

17. The environmental remediant of claim 9 wherein the natural hydrocolloid is arabinoxylin, casein, galactomannan, gelatin, hemicelluose, lignite, lignosulfonate, pectin; starch, tannin or a mixture thereof.

18. The environmental remediant of claim 1 wherein the chemically or biologically active material is detoxifyingly active against an environmental contaminant.

19. The environmental remediant of claim 18 wherein the environmental contaminant is capable of conversion to one or more of the group consisting of nontoxic compounds, compounds less toxic than the environmental contaminant, and complexes which comprise the environmental contaminant.

20. The environmental remediant of claim 18 wherein the environmental contaminant can adsorb upon the remediant.

21. The environmental remediant of claim 1 wherein the chemically or biologically active material comprises metal, zero-valent metal, metal oxide, an organic compound, an oxidant, a reductant, a catalyst, an enzyme, a biologically-active molecule, a biological organism or a mixture thereof.

22. The environmental remediant of claim 1 wherein the particles comprise nanoparticles.

23. The environmental remediant of claim 22 wherein the nanoparticles comprise at least one of Ag, Al, Au, Cu, Fe, Mg, Ni, Pd, Pt, and Zn.

24. The environmental remediant of claim 23 wherein the nanoparticles comprise a first metal and a second metal.

25. The environmental remediant of claim 24 wherein the first metal possesses a reducing property and the second metal possesses a catalytic property.

26. The environmental remediant of claim 24 wherein the nanoparticles are M—Fe nanoparticles, wherein M is Ni, Pd or Pt.

27. The environmental remediant of claim 26 wherein the nanoparticles are M—Fe in a ratio of about 1:500 to about 1:1.

28. The environmental remediant of claim 24 wherein the environmental contaminant comprises chlorinated hydrocarbon.

29. The environmental remediant of claim 24 wherein the first metal and the second metal are disposed with an electrical connection therebetween.

30. An environmental remediant comprising a particle for augmenting the elimination of an environmental contaminant from a remediation site, and a polymeric support molecule, wherein the particle has an effective diameter of 1 micron or less.

31. The environmental remediant of claim 30 wherein the particle has reactive or catalytic properties for detoxifying the environmental contaminant.

32. The environmental remediant of claim 31 wherein the particle comprises at least one of Ag, Al, Au, Cu, Fe, Mg, Ni, Pd, Pt, and Zn.

33. The environmental remediant of claim 30 wherein the environmental contaminant can adsorb upon the remediant.

34. The environmental remediant of claim 30 wherein the polymeric support molecule is soluble in a solvent.

35. The environmental remediant of claim 34 wherein the solvent is environmentally acceptable.

36. The environmental remediant of claim 35 wherein the solvent is aqueous.

37. The environmental remediant of claim 36 wherein the effective diameter of the polymeric support molecule is sufficiently small in relation to the effective diameter of a soil pore at the remediation site.

38. The environmental remediant of claim 37 wherein the polymeric support material does not substantially bind to a clay or negatively-charged particle in a soil layer at the remediation site.

39. The environmental remediant of claim 30 wherein the polymeric support material comprises a macroscopic hydrophobic surface, or ligating groups to retain the particle.

40. The environmental remediant of claim 39 wherein the ligating groups comprise at least one of aldehydes, alcohols, amines, carboxamates, carboxylates, ethers, hydroxamates, ketones, nitrites, phosphonates, phosphates, pyridines, sulfonates, or combinations thereof.

41. An environmental remediant for remediating contaminated soil or water comprising at least one chemically or biologically active material comprising particles having average diameter, as measured by optical or electron microscopy, less than about 1 micron; and
a carrier, which is soluble or miscible or capable of forming a suspension in an environmentally acceptable solvent;
at least a majority of said particles transiting at least 30 cm. of soil following application to the surface of said soil upon solvent irrigation of said soil.

42. The environmental remediant of claim 41 wherein the contaminated soil or water comprise a subterranean locus of remediation.

43. The environmental remediant of claim 42 wherein the subterranean locus of remediation is beneath a vadose zone.

44. The environmental remediant of claim 43 wherein at least a majority of said particles transit through the vadose zone to the subterranean locus of remediation.

45. The environmental remediant of claim 43 wherein the particles comprise zero-valent metals.

46. The environmental remediant of claim 45 wherein the particles are M—Fe nanoparticles, wherein M is Ni, Pd, or Pt.

47. The environmental remediant of claim 46 wherein the nanoparticles are M—Fe in a ratio of about 1:500 to about 1:1.

48. The environmental remediant of claim 47 wherein the carrier has a net negative charge at a pH of use.

49. The environmental remediant of claim 48 wherein the pH of use is between from about 5 to about 9.

50. The environmental remediant of claim 41 which forms a colloidal suspension in an environmentally acceptable solvent.

51. The environmental remediant of claim 41 wherein the carrier prolongs the effective lifetime of the particles.

52. The environmental remediant of claim 41 wherein the carrier comprises at least one of carbonaceous materials, synthetic polymers, natural polymers, metal oxides, nonmetal oxides, or mixtures thereof.

53. The environmental remediant of claim 41 wherein the contaminated soil or water contains one or more environmental contaminants.

54. The environmental remediant of claim 53 wherein the one or more environmental contaminants can adsorb upon the remediant.

55. The environmental remediant of claim 53 wherein the environmental contaminants comprise at least one halogenated organic compound.

56. The environmental remediant of claim 55 wherein the halogenated organic compound is a chlorinated hydrocarbon.

57. The environmental remediant of claim 55 wherein the remediation comprises reductive dehalogenation.

58. The environmental remediant of claim 55 wherein the remediation comprises hydrodehalogenation.

59. The environmental remediant of claim 55 wherein the environmental contaminant is substantially remediated without an accumulation of more toxic by-products.

60. A method for reducing the presence of a contaminant in sub-surface soil or water comprising:
selecting an environmental remediant which is chemically or biologically active with the contaminant;
contacting the sub-surface soil or water with a composition comprising the remediant in the form of particles, said particles having mean diameter, as measured by optical or electron microscopy, less than about 1 micron, together with a carrier, said carrier soluble or miscible or capable of forming a suspension in an environmentally acceptable solvent in an amount effective to detoxify the contaminant, thereby reducing the presence of the contaminant in the subsurface soil or water.

61. The method of claim 60 comprising, prior to contacting the subsurface soil or water with a composition comprising the remediant, the additional step of:
contacting a surface overlaying said soil or water with a composition comprising the remediant in the form of particles, said particles having average diameter, as measured by optical or electron microscopy, less than about 1 micron, together with a polymeric carrier, said carrier soluble or miscible or capable of forming a suspension in an environmentally acceptable solvent; and an environmentally acceptable solvent; wherein at least a portion of the particles transit to the subsurface soil or water.

62. The method of claim 60 further comprising the step of selecting the polymeric carrier to be capable of suspending the particles at a pH range extant from the surface overlaying the soil to a subsurface environment of the soil to be remediated.

63. The method of claim 60 wherein the contacting comprises subsurface injection of the composition.

64. The method of claim 60 wherein the remediant comprises at least one of a metal, a zero-valent metal, a metal oxides, an organic compound, an oxidant, a reductant, a catalyst, an enzyme, a biologically-active molecule or portion thereof, or a biological organism or portion thereof, or a mixture thereof.

65. The method of claim 60 wherein the remediant comprises nanoparticles.

66. The method of claim 65 wherein the nanoparticles comprise at least one of Ag, Al, Au, Cu, Fe, Mg, Ni, Pd, Pt, or Zn.

67. The method of claim 65 wherein the nanoparticles comprise a first metal possessing a reductant property and a second metal possessing a catalytic property.

68. The method of claim 67 wherein the first metal and the second metal are disposed with an electrical connection therebetween.

69. The method of claim 65 wherein the nanoparticles are M—Fe nanoparticles wherein M is Ni, Pd, or Pt.

70. The method of claim 69 wherein the nanoparticles are M—Fe in a ratio of about 1:500 to about 1:1.

71. The method of claim 65 wherein the contaminant comprises at least one halogenated organic compound.

72. The method of claim 71 wherein the halogenated organic compound comprises a chlorinated hydrocarbon.

73. The method of claim 60 wherein the carrier comprises at least one of carbonaceous particles, synthetic polymer, natural polymer, metal oxide, nonmetal oxide, or a mixture thereof.

74. The method of claim 60 wherein the carrier comprises a porous material.

75. The method of claim 60 wherein the carrier has a surface to volume ratio equal to or greater than the remediant.

76. The method of claim 60 wherein the carrier comprises a water-soluble polymer.

77. The method of claim 76 wherein the water-soluble polymer is synthetic polymer, microbial product, marine gum, seed gum, plant exudate, natural hydrocolloid, or a mixture thereof.

78. The method of claim 60 wherein the environmentally acceptable solvent is aqueous.

79. The method of claim 60 wherein the particles have mean diameter, as measured by electron microscopy, less than a mean pore size of the sub-surface soil and an overlaying soil.

80. The method of claim 60 wherein the carrier forms a persistent suspension with the particles.

81. An environmental remediant comprising zero-valent metal particles less than 1 micron in diameter, as determined by electron microscopy, coupled with a polymeric carrier molecule; wherein the polymeric carrier is soluble or miscible in a environmentally acceptable solvent and capable of maintaining the particles suspended in said solvent for a period of time longer than said particles remain suspended without the polymeric carrier.
